(19) United States
(12) Patent Application Publication
(10) Pub. No.: US 2002/0026399 A1
(43) Pub. Date: Feb. 28, 2002

(54) Securities trading system and related method using security pools

(76) Inventors: Lalit Narayan, Princeton Junction, NJ (US); Dechu P. Muthana, New York, NY (US)

Correspondence Address: R. Neil Sudol, Coleman Sudol Sapone P.C., 14th Floor, 708 Third Avenue, New York, NY, 10017, US

(21) Appl. No.: 09/766,714

(22) Filed: Jan. 22, 2001

Related U.S. Application Data
(60) Provisional application No. 60/227,158, filed on Aug. 22, 2000.

(51) Int. Cl. G06F 17/60

(52) U.S. Cl. 705/37; 705/36

(57) ABSTRACT

In a commodities trading method, a specification is received from a potential buyer of at least one of a plurality of parameters characterizing tradable commodities of a common class. A database of commodity parameters is automatically or electronically searched to locate particular commodities having the specified parameter. Upon completion of the search or in response to the search results, identifications of all particular commodities having the specified parameter are provided to the potential buyer.

### CROSS-REFERENCE TO RELATED APPLICATION

This application relies for priority purposes on U.S. provisional application No. 60/227,158 filed Aug. 22, 2000.

### BACKGROUND OF THE INVENTION

This invention relates to the trading of commodities. More particularly, this invention relates to a method and an associated system providing for the trading of commodities such as securities and other financial instruments which are characterized by particular values of sets of investment parameters.

Trading mechanisms today identify fixed income securities based on unique alphanumeric identifiers, i.e., by CUSIP, CEDEL or ISMA numbers. The only convenient method available to market participants today to trade in securities such as bonds is to identify a security by such alphanumeric identifiers, even though the market participants may have other detailed information pertaining to the target securities, such as coupon rates, payment schedule, maturity, redemption features, credit quality and tax status. Generally, a bond order includes such particulars as an alphanumeric identifier, e.g., CUSIP, a price, a quantity and an associated condition (all or none, minimum number of bonds, etc.), time in force (immediate or cancel, fill or kill, good two minutes, etc.), and account identification information.

A search for a particular bond can frequently be a long and tedious process if the alphanumeric identifier for the instrument is not known. This may be the result even though the investor might have all other information pertaining to the type of security to be bought.

### OBJECTS OF THE INVENTION

An object of the present invention is to provide a method and/or system for facilitating the trading of tradable commodities.

A more particular object of the present invention is to enable a market participant to engage in securities trading without requiring the market participant to identify securities of interest by their particular CUSIP, CEDEL or ISMA numbers.

A further object of the present invention is to provide a trading system and/or method which may be implemented automatically, without operator intervention.

Yet another object of the present invention is to provide a trading system and/or method which may be implemented via the Internet.

These and other objects of the present invention will be apparent from the drawings and descriptions herein. It is to be noted that any one embodiment of the present invention may satisfy one or more of the above-described objects, but not necessarily all of the stated objects.

### SUMMARY OF THE INVENTION

The present invention recognizes that tradable securities have variables or parameters, other than unique alphanumeric identifiers assigned to the securities, which could alternatively serve as identifiers. Such variables or parameters include coupon rates, payment schedule, maturity, redemption features, credit quality and tax status. Pursuant to the invention, a prospective trader or market participant placing a trading order may provide specific details as to one or more of these variables or parameters in lieu of an alphanumeric bond identifier (e.g., CUSIP). Thus, a buyer could submit investment criteria such as maturity and coupon rate. These investment criteria function as search criteria for an automated selection or pooling of potentially tradable securities. Alternatively, as discussed below, a trading system in accordance with the invention might create predefined pools such as a high-risk, long-term pool. In that case, the individual or institutional trader selects one of the predefined pools for a trade. Another possibility is that the user or trader may specify some existing bonds he or she already has in his or her portfolio and then the eligible bonds constituting the pool would be those that help the user to achieve certain overall portfolio metrics. In any case, the user or trader specifies an acceptable price in the form of a target yield, as well as other desired trade particulars including a quantity, a time in force, and trading account identification information.

The invention contemplates the formation of security pools which are characterized or defined by one or more common parameters. The security pools may be formed in part prior to the reception of search criteria from prospective market participants. Alternatively, the security pools may be defined in part by the search criteria submitted by the prospective market participants. Thus, a market participant in commodities such as fixed income securities can construct a pool of securities based on different investment parameters and place orders for units of any security that matches the characteristics of the other securities within that pool. This method contrast with an alternative wherein the market participant randomly places orders for units of a specific security, by CUSIP number.

The underlying logic of the present invention is that market participants are generally indifferent between various bonds as long as the bonds satisfy a basic set of investment criteria. An example would be of 60 different bonds that mature between 24 to 30 months, have coupon rates between 5 to 6 percent, and whose yield to maturity varies from 6% to 7%. These investment criteria, if submitted by the market participant to a properly programmed digital computer, can serve as search criteria for defining or generating one or more pools of securities.

A method for use in trading commodities comprises, in accordance with the present invention, receiving from a potential buyer a specification of at least one of a plurality of parameters characterizing tradable commodities of a common class, automatically or electronically searching a database of commodity parameters to locate particular commodities having the specified parameter, and, upon completion of the search or in response to the search results, providing to the potential buyer identifications of all particular commodities having the specified parameter.

Generally, where the commodity is a fixed income security, the specified parameter is taken from a group including tax status, redemption features, credit quality, coupon rate, payment schedule, and maturity. The specified parameter functions as a search criterion and identifies an investment goal or target of the potential buyer or market participant.

After the search has been run, the potential buyer may be provided, for example, with a table listing suitable bonds by CUSIP number, and setting forth the various investment parameters of the bonds, including coupon rate, payment schedule, maturity, redemption features, credit quality, and tax status. It is possible to furnish the tables, at the option of the potential buyer, with only some entries or with the various entries in different orders.

In accordance with another feature of the present invention, the method further comprises receiving, from the potential buyer, an order including at least one order parameter, detecting, among the particular commodities identified to the potential buyer, a match to the order, and executing the order. The one order parameter may be taken from a group including price, yield, order type, time in force, and quantity conditions.

Pursuant to another feature of the present invention, the method additionally comprises providing the potential buyer with a plurality of pool type options prior to receiving the specified parameter from the potential buyer, and subsequently receiving from the potential buyer a selection as to a desired pool type consonant with investment goals of the potential buyer. In this scenario, the searching of the database takes place only after the selection as to a desired pool and the specified parameter have been received from the potential buyer. Also, the searching of the database entails searching for only those commodities of the pool type selected by the potential buyer.

In an example of the use of pool type options to facilitate trading activities and more particularly, the locating of acceptable fixed income securities by a prospective purchaser, the prospective purchaser is asked whether he or she is interested in high risk or low risk investments and long-term or short-term investments. The prospective purchaser may be provided with a choice among four investment goals: high-risk long- term, high-risk short-term, low-risk long-term, and low-risk short term. Each of these investment goals corresponds to a respective predefined set of securities. The securities in each set may differ from one another in one or more investment parameters such as tax status, redemption features, coupon rate, and payment schedule. However, smaller securities pools may be formed, prior to or in the absence of preference indication from any prospective buyer. For example, the high-risk long-term pool may be subdivided into several pools having coupon rates of 0-5%, 5-10%, 10-15%, etc. However, it is contemplated that smaller pools are defined not by predetermined search criteria but by search parameters specified by the individual users or buyers.

Other criteria for organizing pools of securities involve investment goals such as capital preservation, capital growth, income generation, and speculation.

The present invention contemplates an automatic implementation of the methodology. More particularly, the receiving of the specification from the potential buyer, the automatic or electronic searching the database, and the providing to the potential buyer of identifications of all particular commodities having the specified parameter are all performed automatically, in an absence of operator intervention. In a specific embodiment of the methodology, the receiving of the specification from the potential buyer includes the receiving of signals over a global computer network (the Internet). Concomitantly, the providing to the potential buyer of identifications of all particular commodities having the specified parameter includes the transmitting of signals over the Internet, e.g., via World Wide Web pages.

Pursuant to further features of the present invention, confirmations are sent to prospective buyers in response to the submission of specifications for possible orders for trades. The methodology includes the option of requiring a confirmation from a prospective buyer prior to the consummation of a trade. In some applications, the confirmation from the prospective buyer may be omitted, particularly where a specified parameter is accompanied by other order parameters and an authorization to execute a trade on any security meeting the specifications and order.

An associated system for use in trading commodities comprises, in accordance with the present invention, (a) a database storing, for each of a plurality of commodities, respective particular entries for each of a plurality of investment-related parameters, (b) a communications link for carrying, from a potential buyer, a specification of at least one of a plurality of parameters characterizing tradable commodities of a common class, (c) a decoder operatively connected to the communications link for detecting the specification of the one of the plurality of parameters, (d) a search module operatively linked to the decoder and the database for automatically or electronically searching the database to locate particular commodities having the specified parameter, and (e) an encoder operatively connected to the search module and the communications link for providing to the potential buyer identifications of all particular commodities having the specified parameter.

As discussed above, where the commodities targeted by the system are bonds, the investment-related parameters include one or more of the following: tax status, redemption features, credit quality, coupon rate, payment schedule, and maturity. The database thus stores, as memory cell entries, the particular values of these parameters for each bond which is up for possible sale.

The communications link may include a twisted pair, a coaxial cable, an optical fiber, or a wireless ground or satellite pathway. Alternatively or additionally, the communications link may include a connection to a computer network, whether a private network or the global computer network known as the Internet or a closed, password-protected subset of the Internet called an “Intranet.” At the users' end, the market participants may transmit and receive signals from desktop computers, laptop computers, personal digital assistants, cellular telephones, etc.

It is to be noted that the various components of a system in accordance with the present invention are preferably realized as generic circuits of a general-purpose digital computer where the generic circuits are modified by programming to accomplish the respective functions. Of course, the same components may instead be realized as specially programmed components of a digital microprocessor or hard-wired elements of a dedicated electronic apparatus.

Pursuant to additional features of the present invention, the system also comprises (f) an order interpretation module operatively connected to the communications link for detecting an order from the potential buyer, the order including at least one order parameter, (g) a comparison circuit operatively connected to the order interpretation module and to the database for detecting, among the particular commodities identified to the potential buyer, a match to the order, and (h) an order execution module operatively linked to the comparison circuit for executing a trade on the order upon detecting of a match to the order.

Pursuant to yet another feature of the present invention, the system further comprises a second encoder operatively connected to the communications link and to the database for advising the potential buyer as to a plurality of pool type options prior to receipt of the specified parameter from the potential buyer. In that event, a second decoder is operatively connected to the communications link for detecting a selection from the potential buyer as to a desired pool type consonant with investment goals of the potential buyer. The second decoder is operatively connected to the search module to indicate to the search module the selection from the potential buyer as to desired pool type, so that the search module searches in the database for only those commodities of the pool type selected by the potential buyer.

The system may include a classification module operatively connected to the communications link for grouping offered commodities in pools depending on particular parameters characterizing the offered commodities. The commodity pools are defined at least in part by investment goals and tolerance for risk.

The system preferably further comprises an order execution module operatively linked to the search module for executing a trade on a commodity listed in the database and uncovered by the search module.

The present invention allows investors to place an order (e.g., 5000 bonds of any of the 60 different CUSIPs) for a specified quantity of securities based on a pool of security that was constructed to suit a particular set of investor preferences. For example, an investor may specify a buy limit order at minimum 7.5% yield to maturity. The investor may also specify other criteria like All or None, Good Till Cancel, et cetera. At some time in the future, the yield on one of these CUSIPs would equal to or exceed 7.5% and that bond would then, automatically be purchased by the investor.

### BRIEF DESCRIPTION OF THE DRAWINGS

The above and other objects, features and advantages of the present invention will now be described in more detail with reference to the accompanying drawings in which:

FIG. 1 is a block diagram illustrating a system in accordance with the present invention.

FIG. 2 is a flow chart diagram illustrating how a customer or potential buyer goes through the process of launching a search for a particular security based on a particular pool's characteristics.

FIG. 3 is a flow chart diagram of the detailed methodology on how a security is matched to specified search criteria.

FIG. 4 is a block diagram illustrating functional components of a server computer shown in FIG. 1.

### DEFINITIONS

A “tradable commodity” is used herein to designate an item or product capable of being bought and sold and which has characteristics of existing in multiple units, having comprehensively measurable parameters, having standardized features, and being of non-perishable quality. Comprehensively measurable parameters of an item or product can be accurately measured and specified. The standardization of features means that all units of the item or product are absolutely identical to one another, with no variations between different units for that particular product. A non-perishable product retains its intrinsic value for its term as determined by economic market factors, and does not diminish in such value due to any physical factors such as, wear and tear, for example. Tradable commodities include financial instruments such as stocks, bonds, options, futures and annuities, which have a secondary market.

The term “investment parameter” or “parameter characterizing a tradable commodity” is used herein to refer to a characteristic relevant to investment value used to define a specific tradable commodity. Where a commodity is a security such as a bond, the relevant parameters are particular values or instances of coupon rate, payment schedule, maturity, redemption features, credit quality, and tax status.

The term “specification of a parameter” is used herein in the context of an order or inquiry from a potential market participant. A “specified parameter” denotes a particular value or instance of an investment parameter and constitutes a search criterion. Examples of specific investment parameters or search criteria includes a particular coupon rate or range of coupon rates, a maturity date or interval, a credit quality or group of credit ratings, etc.

The word “order” is used herein to denote a request by a potential trader or market participant to consummate a trade. An order sets forth at least a price for a purchase and may include additional order parameters such as order type (limit, market), time in force, and quantity of commodity or security units.

The word “pool” is used herein with reference to a group, set, or collection of commodities which share at least one specified parameter. More generally, the word “pool” is also used herein to designate a group, set, or collection of commodities which share one or more investment characteristics or which exhibit an investment behavior of interest to a group of investors. Accordingly, one large pool of bonds includes those of high risk. A more specific pool of bonds are high-risk, short-term bonds. An even more specific pool of bonds consists of high-risk, short-term bonds have a coupon rate between 4% and 5% and a yield between 6% and 7%.

### DESCRIPTION OF THE PREFERRED EMBODIMENTS

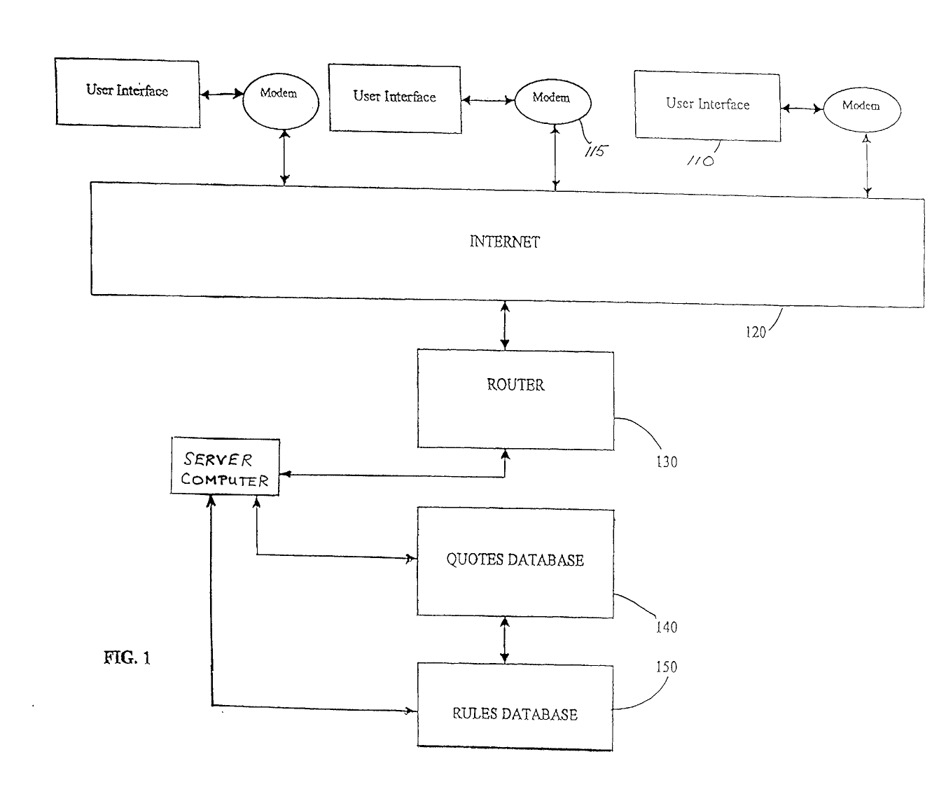

As illustrated in FIG. 1, a computer based system for facilitating trading in commodities such as fixed-income securities comprises a plurality of user interfaces 110 which function as input and output gateways for communications with a central server 112. User interfaces 110 may particularly take the form of a browser on a personal computer connected to the global computer network 120 known as the Internet via respective modems 115 or other connection devices. User interfaces 110 communicate with a routing module 130 via the Internet 120. Routing module 130 in turn directs trading communications to server computer 112.

Server computer 112 incorporates or is connected to a quotes database 140 which stores data pertaining to bonds and other securities which have been offered for sale. Quotes database 140 includes an identification of each bond by CUSIP, CEDEL or ISMA number, as well as various investment parameters peculiar to the bond. These investment parameters include the tax status, redemption features, credit quality, the coupon rates, payment schedules, and maturities of the listed bonds.

The investment parameter data in quotes database 140 may be organized by server computer 112 into groupings or sets defined by common parameters among the various listed bonds. For example, all data relating to bonds considered as high-risk investments may be stored in one memory area, while all data relating to bonds considered to be low-risk investments may be stored in another memory area. These data may be further subdivided so that the data in the high-risk area is grouped into long-term and short-term sets. The long-term and short-term sets may be further subdivided into sets defined, for example, by coupon rate so that data pertaining to bonds with coupon rates of 0-5% are located in a different memory area from data relating to bonds having yields of 5-10%. These groupings and subgroupings may be understood as predefining a plurality of commodity pools.

Computer 112 may be programmed to index the bond data according to respective values or ranges of values of the various investment parameters. This indexed data structure may also be understood as predefining a plurality of commodity pools. A first set of indices may be generated, for instance, to list bonds having coupon rates of 0-5%, 5-10%, 10-15%, etc. A second set of indices may list bonds having maturities of 0-3 months, 3-6 months, 6-12 months, 12-18 months, 18-24 months, etc. These indices facilitate searches in response to requests submitted by potential bond buyers.

Sever computer 112 additionally incorporates or is connected to a database 150 storing search parameters and order information submitted by potential buyers via interfaces 110 and the Internet 120.

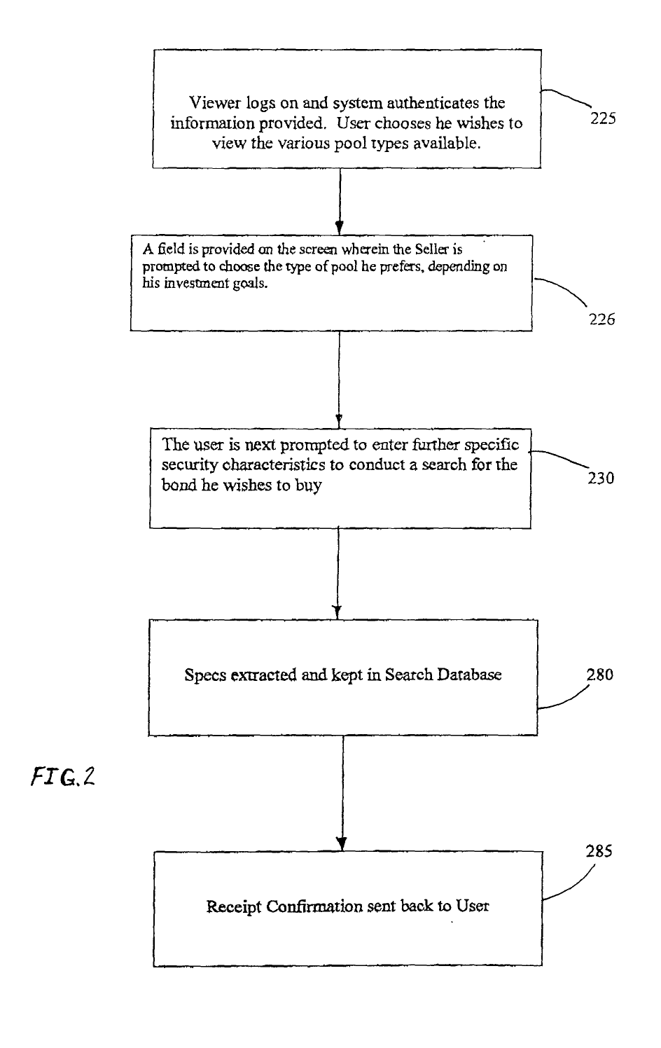

As shown in FIG. 2, a user logs on and gets authenticated at a step 225. The user also indicates that he or she wishes to view the various pool type options that are available, to set the base of his search criteria. At a step 226, the user chooses the pool type according to his or her investment goals. At a step 230, server computer 112 prompts the user to enter further specifications to the choice of security that should be searched for. At a step 280, the server computer extracts the user-provided specifications for the search and stores those specification in database 150. At a step 285, server computer 112 sends a receipt confirmation back to the user with a record of the search criteria requested.

The search criteria transmitted by the user at step 230 are used by server computer 112 to generate, from the data in database 140, at least one subgrouping, set, or sub-pool of bond data from the pool selected by the user at step 226. The size of the subgrouping, set or sub-pool depends in large measure on the particular specifications submitted by the user. A specification of a coupon rate of 6-7% will usually, but not necessarily, result in a larger number of selected bonds than a specification of a coupon rate of 6-7%, with a maturity of six months to nine months.

Server computer 112 may conduct a search of database 140 pursuant to search criteria stored in database 150 together with a rule (generally selected or confirmed by the user) as to how trades are to be executed on the search results. There are at least two modes of combined search and order execution—an active and an inactive search. In a first mode, the search parameters from the user or potential buyer are provided with sufficient specificity to enable computer 112 to select, from the search results, one or more securities on which to execute a trade. The specification from the user necessarily includes an order indicating that a trade may be executed immediately upon locating of a security meeting the search specifications. In a second mode of search and order execution, the specification from the user either explicitly requires confirmation from the user before order execution or else fails to contain enough order information, thereby inherently requiring confirmation and further information from the user.

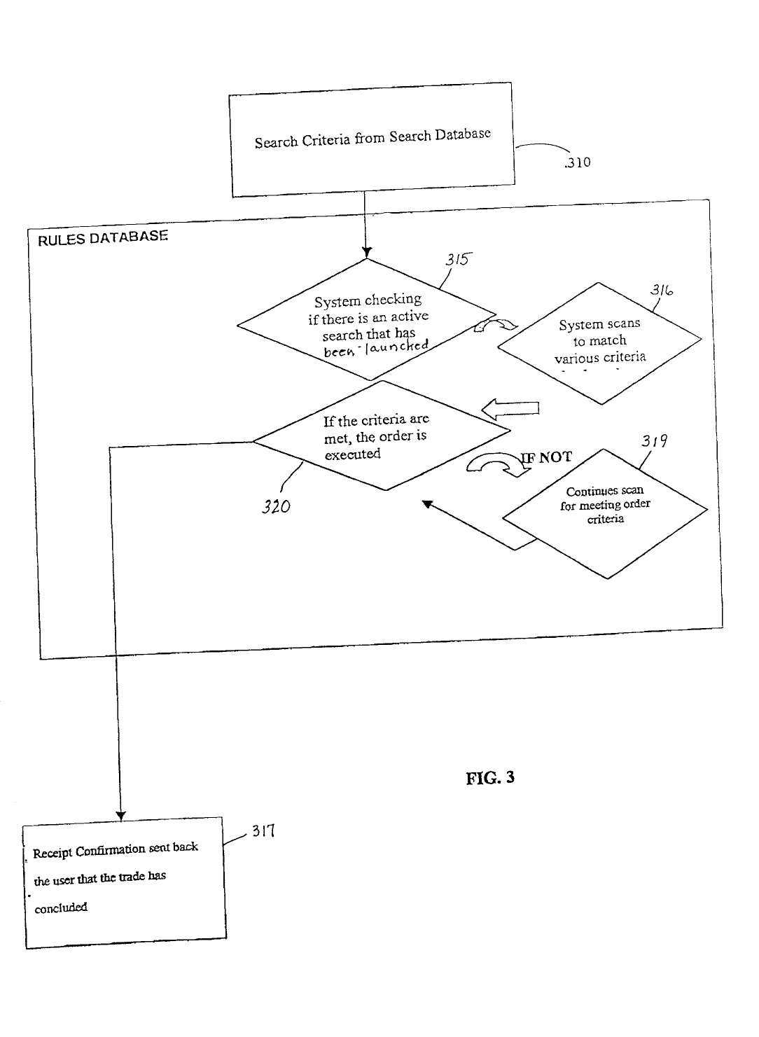

FIG. 3 illustrates steps in a search and order execution process, in accordance with the above-identified first mode. After the user or prospective purchaser logs onto the system and is authenticated, server computer 112 conducts a search in database 140 at a step 310 in accordance with the search specification submitted by the particular user or purchaser. At a step 315, server computer 112 checks rules database 150 to determine whether an active search has been launched, i.e., whether the search specification submitted by the user or purchaser includes or was accompanied by an order to close a transaction. At a step 316, server computer 112 scans the search results for various securities that are a possible match for the search and order criteria that have been set. At another step (not shown), the various securities that have been sorted based on the search criteria submitted, are matched. If matched, at a step 320, the order is executed by server computer 112 and a confirmation is sent back to the user (step 317). If not, server computer 112 performs a step 319 for further sorting of the securities to bring about an order match whereupon step 320 is executed.

Market participants for fixed income securities tailor their investments based on their investment goals, tolerance for risk, and other individual preferences such as price, tax status, redemption features and credit quality. Pursuant to the above-described second mode of search and order execution, a typical investor first identifies a bond by the afore-mentioned factors and subsequently, after being informed as to the search results, places an order for a bond that would meet such criteria. For example, an investor might want to buy a Treasury bond that matures between 24 to 30 months, and a coupon rate of between 5 to 6 percent. After conducting a search in database 140 pursuant to these specifications, server computer advises the user of bonds up for sale which were located in the search. Among the bonds that satisfy these investment criteria, the investor can then place an order for one specific security (example: 5000 bonds of CUSIP 9128273M2). At this stage, the order may include further specification of investment parameters, to further narrow the search, but necessarily includes order parameters such as the desired price/yield and other order criteria like nature (market/limit), time in force (good till cancel, fill or kill etc), conditions (all or none, minimum quantity, lot sizes etc) and so on. Server computer 112 executes a trade for one or more bonds which meet the buyer's specifications and the specific order parameters placed by the buyer.

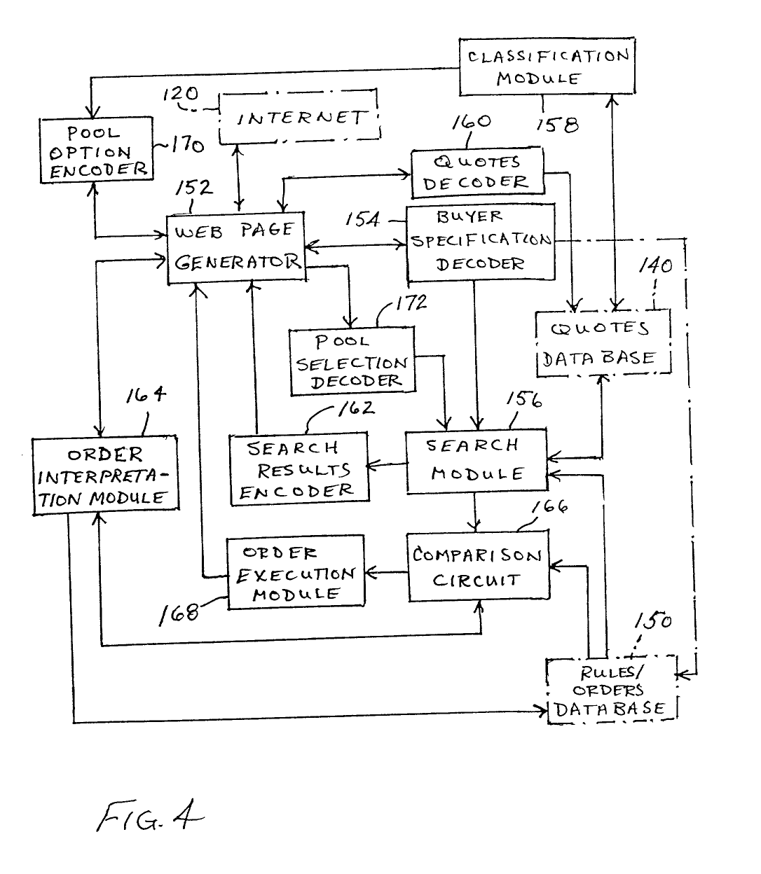

As illustrated in FIG. 4, server computer 112 include a Web page generator 152 operatively linked to the Internet 120 for communicating with user interfaces 110 via one or more Web sites. A decoder 154 is operatively connected to the Internet 120 and user interfaces 110 via Web page generator 152 for detecting the specification of one or more investment parameters serving as search criteria. Decoder 154 functions to isolate a relevant portion of an incoming signal, translate or convert the format of that portion of the signal, if necessary, and interpret the content for purposes of enabling a search of quotes database 140.

Server computer 112 further includes a search module 156 operatively linked to decoder 154 and quotes database 140 for automatically or electronically searching the database to locate particular commodities (e.g., bonds) having the parameter or parameters specified by the user. Search module 156 is designed to access quotes database 140 and scan the contents thereof. The operation of search module 156 may be facilitated by prior grouping of the fixed-income securities or other commodities according to common parameters or by indexing of those parameters.

The organization of the investment parameter data in quotes database 140 into groupings or sets defined by common parameters among the various listed bonds may be accomplished by a classification module 158 of server computer 112. As discussed above with reference to FIG. 1, the groupings or pooling of bond data in quotes database 140 may be implemented particularly by storage configuration or, alternatively, by the creation of indices which group the bond data according to respective values or ranges of values of the various investment parameters.

Server computer 112 further includes a quotes decoder 160 operatively connected to Web page generator 152 for detecting ask quotes (offer to sell) and bond identification information submitted by respective sellers via the Internet 120. Decoder 160 functions to isolate relevant portions of incoming signals, translate or convert the signal formats, as required, and interpret the content for purposes of enabling an insertion of information into quotes database 140.

Server computer 112 may additionally incorporate an Internet search engine (not shown) for accessing appropriate on-line databases to complete the listing of commodity investment parameters or characterizing data in quotes database 140. Thus, the data necessary to effectively perform securities pooling or searching as discussed herein may be obtained from the individual sellers and/or from databases accessible via the Internet or even via dedicated private communications lines (not shown).

As further illustrated in FIG. 4, server computer 112 additionally includes an encoder 162 operatively connected to search module 156 and Web page generator 152 for providing to potential buyers identifications of all particular commodities having the parameters specified by the respective buyers. Encoder 162 operates in part to convert the search results into a form suitable for transmission over the communications link formed in part by the Internet 120. Encoder 162 also serves in part to put the data in a suitable format for presentation to the user on a computer monitor or other display. The format may be tabular and include various summaries or collations of search results. A table will generally list suitable bonds by CUSIP number, and set forth the various investment parameters of the bonds, including coupon rate, payment schedule, maturity, redemption features, credit quality, and tax status. It is possible to furnish the tables, at the option of the potential buyer, with only some entries or with the various entries in different orders.

The various elements of server computer 112 depicted in FIG. 4 are realized as generic digital computer circuits modified by programming to accomplish the respective functions. Alternatively, the components depicted as functional blocks in FIG. 4 may be realized as specially programmed components of a digital microprocessor or as hardwired elements of a dedicated electronic apparatus.

FIG. 4 also shows an order interpretation module 164 operatively connected to the Internet 120 via Web page generator 152 for detecting an order from the potential buyer. As discussed above, an order is a request by a user or potential buyer to consummate a trade. An order sets forth at least a price for a purchase (or yield, in the case of a fixed-income instrument) and may include additional order parameters such as order type (limit, market), time in force, and quantity of commodity or security units.

Order interpretation module 164 is connected to database 150 for storing incoming order information therein. Database 150 may also be connected to decoder 154 for storing specified investment parameters or search criteria.

A comparison circuit 166 is operatively connected to order interpretation module 164 and to database 150 for detecting, among the particular commodities identitifed to the potential buyer, a match to the order. An order execution module 168 is operatively linked to comparison circuit 166 for executing a trade on the order upon detecting of a match to the order.

Order interpretation module 164 functions in part as a decoder which isolates relevant portions of an incoming signal, detects incoming order parameters, possibly converts the signal format, and interprets content for purposes of enabling the comparison by circuit 164 and order completion functions of module 168.

Comparison circuit 166 is designed to access database 140, scan the contents thereof, and compare those contents with the order parameters stored in database 150 to determine whether a match exists so that a trade can be consummated. Comparison circuit 166 detects whether a bid price submitted by a buyer is greater than or equal to the ask price recorded in database 140 for a respective bond or other commodity targeted by that buyer. Again, the operation of the comparison circuit may be facilitated by prior grouping of the fixed-income securities or other commodities according to common parameters or by indexing of those parameters. This grouped or indexed data structure may be understood as predefining a plurality of commodity pools.

Comparison circuit 166 may be connected to search module 156 to look for buy and sell matches in the pools or groups discovered by search module 156 in response to the specification of desired investment parameters by potential buyers.

Server computer 112 further includes a second encoder 170 (FIG. 4) operatively connected to the Internet 120 via Web page generator 152 and to quotes database 140, more particularly to classification module 158, for advising potential buyers as to pool type options. These options are communicated to a prospective buyer at the onset of a transaction, prior to the specification of investment parameters or search criteria by the potential buyer. Under the control of classification module 158, encoder 170 inquires of a prospective purchaser whether he or she is interested in high risk or low risk investments and long-term or short-term investments. The prospective purchaser is exemplarily provided with a choice among four investment goals: high-risk long-term, high-risk short-term, low-risk long-term, and low-risk short term. Each of these investment goals corresponds to a respective predefined set of securities isolated by classification module 158 and separately searchable by search module 156. The securities in each set may differ from one another in one or more investment parameters such as tax status, redemption features, coupon rate, and payment schedule. However, smaller securities pools may be formed, prior to or in the absence of preference indication from any prospective buyer. For example, the high-risk long-term pool may be subdivided into several pools having coupon rates of 0-5%, 5-10%, 10-15%, etc.

As additionally depicted in FIG. 4, a second decoder 172 is operatively connected to the Internet via Web page generator 152 for detecting a selection from a potential buyer as to a desired pool type consonant with investment goals of the potential buyer. This second decoder 172 is operatively connected to search module 156 to indicate thereto the selection from the potential buyer as to desired pool type, so that the search module 156 searches in quotes database 140 for only those commodities of the pool type selected by the potential buyer.

Encoder operates 170 in part to convert the pool options into a form suitable for transmission over the Internet 120 via Web page generator 152. This encoder also serves in part to put the data in a suitable format for presentation to the user on a computer monitor or other display.

Confirmations may be sent to prospective buyers in response to the submission of specifications for possible orders for trades. This confirmation process may be undertaken by decoder 154.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. A method for use in trading commodities, comprising:
receiving from a potential buyer a specification of at least one of a plurality of parameters characterizing tradable commodities of a common class;
automatically or electronically searching a database of commodity parameters to locate particular commodities having the specified parameter; and
providing to said potential buyer identifications of all particular commodities having said specified parameter.

2. The method defined in claim 1, further comprising:
receiving, from said potential buyer, an order including at least one order parameter;
detecting, among the particular commodities identified to said potential buyer, a match to said order; and
executing said order.

3. The method defined in claim 2 wherein said at least one order parameter is taken from the group consisting of price, yield, order type, time in force, and quantity conditions.

4. The method defined in claim 3 wherein said specified parameter is taken from the group consisting of tax status, redemption features, credit quality, coupon rate, payment schedule, and maturity.

5. The method defined in claim 2, further comprising:
providing said potential buyer with a plurality of pool type options prior to receiving said specified parameter from said potential buyer; and
subsequently receiving from said potential buyer a selection as to a desired pool type consonant with investment goals of said potential buyer,
the searching of said database taking place only after the selection as to a desired pool and said specified parameter have been received from said potential buyer,
the searching of said database including searching for only those commodities of the pool type selected by said potential buyer.

6. The method defined in claim 5 wherein said pool type options are particular cases of investment goals and tolerance for risk.

7. The method defined in claim 2 wherein said order is received from said potential buyer prior to the automatic or electronic searching of said database.

8. The method defined in claim 1, further comprising:
providing said potential buyer with a plurality of pool type options prior to receiving said specified parameter from said potential buyer; subsequently receiving from said potential buyer a selection as to a desired pool type consonant with investment goals of said potential buyer,
the searching of said database taking place only after the selection as to a desired pool and said specified parameter have been received from said potential buyer,
the searching of said database including searching for only those commodities of the pool type selected by said potential buyer.

9. The method defined in claim 8, further comprising grouping commodity data, pertaining to commodities for sale, in pools according to respective pool types prior to receiving from said potential buyer said selection as to desired pool type and prior to receiving said specified parameter from said potential buyer.

10. The method defined in claim 9 wherein said pool types are defined at least in part by investment goals and tolerance for risk.

11. The method defined in claim 1 wherein the receiving of said specification from said potential buyer, the automatic or electronic searching said database, and the providing to said potential buyer of identifications of all particular commodities having said specified parameter are all performed automatically, in an absence of operator intervention.

12. The method set forth in claim 11 wherein the receiving of said specification from said potential buyer includes the receiving of signals over a global computer network, the providing to said potential buyer of identifications of all particular commodities having said specified parameter including the transmitting of signals over said global computer network.

13. The method set forth in claim 12, further comprising transmitting information to said potential buyer via World Wide Web pages.

14. The method defined in claim 1, further comprising providing said potential buyer with a plurality of pool type options prior to receiving said specified parameter from said potential buyer, said specification received from the potential buyer constituting a selection as to a desired pool type consonant with investment goals of said potential buyer, the searching of said database including searching for only those commodities of the pool type selected by said potential buyer.

15. The method defined in claim 14, further comprising:
receiving, from said potential buyer, an order including at least one order parameter;
detecting, among the particular commodities identified to said potential buyer, a match to said order; and
executing said order.

16. The method defined in claim 1, further comprising:
storing said specified parameter from said potential buyer; and
sending a confirmation back to said potential buyer as to said specified parameter.

17. The method defined in claim 1, further comprising:
receiving, from said potential buyer, an order for particular one of the commodities identified to said potential buyer; and
executing said order.

18. The method defined in claim 1 wherein the specification received from said potential buyer includes a price and constitutes an order, further comprising:
after searching said database, detecting at least one tradable commodity satisfying said order; and
thereafter automatically executing on said order.

19. The method defined in claim 1 wherein said specified parameter is taken from the group consisting of tax status, redemption features, credit quality, coupon rate, payment schedule, and maturity.

20. A method for use in trading commodities, comprising:
receiving from a potential buyer a specification of at least one of a plurality of parameters characterizing tradable commodities of a common class;
automatically or electronically searching a database of commodity parameters to locate particular commodities having the specified parameter; and
automatically executing a trade for at least one particular commodity found during the searching of said database.

21. The method defined in claim 20, further comprising:
providing said potential buyer with a plurality of pool type options prior to receiving said specified parameter from said potential buyer;
subsequently receiving from said potential buyer a selection as to a desired pool type consonant with investment goals of said potential buyer,
the searching of said database taking place only after the selection as to a desired pool and said specified parameter have been received from said potential buyer,
the searching of said database including searching for only those commodities of the pool type selected by said potential buyer.

22. The method defined in claim 21 wherein said pool types are defined at least in part by investment goals and tolerance for risk.

23. The method defined in claim 20, further comprising receiving, from said potential buyer prior to the executing of said trade, an order for said particular commodity.

24. The method defined in claim 20 wherein the receiving of said specification from said potential buyer, the automatic or electronic searching said database, and the executing of said trade are all performed automatically, in an absence of operator intervention.

25. The method set forth in claim 24 wherein the receiving of said specification from said potential buyer includes the receiving of signals over a global computer network.

26. The method defined in claim 20 wherein said specified parameter is taken from the group consisting of tax status, redemption features, credit quality, coupon rate, payment schedule, and maturity.

27. A system for use in trading commodities, comprising:
a database storing, for each of a plurality of commodities, respective particular entries for each of a plurality of investment-related parameters;
a communications link for carrying, from a potential buyer, a specification of at least one of a plurality of parameters characterizing tradable commodities of a common class;
a decoder operatively connected to said communications link for detecting said specification of said one of said plurality of parameters;
a search module operatively linked to said decoder and said database for automatically or electronically searching said database to locate particular commodities having the specified parameter; and
an encoder operatively connected to said search module and said communications link for providing to the potential buyer identifications of all particular commodities having the specified parameter.

28. The system defined in claim 27, further comprising:
an order interpretation module operatively connected to said communications link for detecting an order from the potential buyer, said order including at least one order parameter;
a comparison circuit operatively connected to said order interpretation module and to said database for detecting, among the particular commodities identitifed to the potential buyer, a match to the order; and
an order execution module operatively linked to said comparison circuit for executing a trade on the order upon detecting of a match to the order.

29. The system defined in claim 28 wherein the one order parameter is taken from the group consisting of price, yield, order type, time in force, and quantity conditions, the specified parameter being taken from the group consisting of tax status, redemption features, credit quality, coupon rate, payment schedule, and maturity.

30. The system defined in claim 27 wherein said database stores data defining a plurality of commodity pools, said decoder being a first decoder, said encoder being a first encoder, further comprising:
a second encoder operatively connected to said communications link and to said database for advising said potential buyer as to a plurality of pool type options prior to receipt of the specified parameter from the potential buyer; and
a second decoder operatively connected to said communications link for detecting a selection from the potential buyer as to a desired pool type consonant with investment goals of the potential buyer,
said second decoder being operatively connected to said search module to indicate to said search module the selection from the potential buyer as to desired pool type, so that said search module searches in said database for only those commodities of the pool type selected by the potential buyer.

31. The system defined in claim 30, further comprising a classification module operatively connected to said communications link for grouping offered commodities in pools depending on particular parameters characterizing the offered commodities.

32. The system defined in claim 31 wherein the commodity pools are defined at least in part by investment goals and tolerance for risk.

33. The system set forth in claim 27 wherein said communications link is connected to a global computer network.

34. The system set forth in claim 27, further comprising a World Wide Web page generator, said decoder and said encoder being connected to said page generator.

35. The system defined in claim 27, further comprising an order execution module operatively linked to said search module for executing a trade on a commodity listed in said database and uncovered by said search module.

36. A system for use in trading commodities, comprising:
a database storing, for each of a plurality of commodities, respective particular entries for each of a plurality of investment-related parameters;
a communications link for carrying, from a potential buyer, a specification of at least one of a plurality of parameters characterizing tradable commodities of a common class;
a decoder operatively connected to said communications link for detecting said specification of said one of said plurality of parameters;
a search module operatively linked to said decoder and said database for automatically or electronically searching said database to locate particular commodities having the specified parameter; and
an order execution module operatively linked to said search module for executing a trade on a commodity listed in said database and uncovered by said search module.

37. The system defined in claim 36 wherein said database stores data defining a plurality of commodity pools, said decoder being a first decoder, further comprising:
a second encoder operatively connected to said communications link and to said database for advising said potential buyer as to a plurality of pool type options prior to receipt of the specified parameter from the potential buyer; and
a second decoder operatively connected to said communications link for detecting a selection from the potential buyer as to a desired pool type consonant with investment goals of the potential buyer,
said second decoder being operatively connected to said search module to indicate to said search module the selection from the potential buyer as to desired pool type, so that said search module searches in said database for only those commodities of the pool type selected by the potential buyer.
